(19) United States
(12) Patent Application Publication
(10) Pub. No.: US 2026/0050308 A1
(43) Pub. Date: Feb. 19, 2026

(54) SYSTEM AND METHOD FOR DESIGNING A POWER MANAGEMENT CONTROLLER USING A NO-CODE APPROACH

(71) Applicant: ITDA SEMICONDUCTOR CO., LTD., Hwaseong-si (KR)

(72) Inventors: Ingyu KIM, Hwaseong-si (KR); Hoyeon JEON, Seongnam-si (KR); Ahchan KIM, Hwaseong-si (KR)

(73) Assignee: ITDA SEMICONDUCTOR CO., LTD., Hwaseong-si (KR)

(21) Appl. No.: 19/213,745

(22) Filed: May 20, 2025

(30) Foreign Application Priority Data
Aug. 13, 2024 (KR) 10-2024-0108213

(51) Int. Cl. G06F 1/26; G06F 8/35; G06F 9/30

(52) U.S. Cl. CPC G06F 1/26; G06F 8/35; G06F 9/30101

(57) ABSTRACT

Disclosed are a system and method for designing a power management controller that performs power control of a plurality of power domains in a system-on-chip (SoC) device using a no-code approach. The system comprises a memory configured to store instructions and a processor configured to execute the instructions. The instructions include operations for generating a root power manager instance based on a root power manager component, generating at least one domain power manager instance based on one or more domain power manager components, establishing connections between output ports of the root power manager instance and input ports of the domain power manager instances, allocating memory storage space for each power manager instance, and generating hardware code of power elements, register code corresponding to the power elements, hardware code corresponding to ports and connections, and binary code corresponding to an operation sequence of the power management controller.

### CROSS-REFERENCE TO RELATED APPLICATION

This application claims the benefit of and priority to Korean Patent Application No. 10-2024-0108213, filed on Aug. 13, 2024, the entire disclosure(s) of which is hereby incorporated herein by reference in its entirety.

### TECHNICAL FIELD

The present disclosure relates to design of a power management controller for power control of a system-on-chip device, and more specifically, to a system and method for designing a power management controller that performs power control of a plurality of power domains constituting a system-on-chip device using a no-code approach.

### BACKGROUND

System-on-chip (SoC) refers to a technology for integrating various function blocks such as a central processing unit (CPU), a memory, an interface, a digital signal processing circuit, and an analog signal processing circuit into a single semiconductor integrated circuit to implement a computer system or other electronic systems, or an integrated circuit (IC) integrated according to the technology. SoC is developing into a more complex system that includes various function blocks such as a processor, multimedia, graphics, interface, and security.

In general, it is important to properly design the power and clock systems in an SoC. SoC requires a power management controller for appropriately managing power, and when designing a system-on-chip, it is necessary to design a power management controller for power control of a plurality of power domains.

The typical power and clock design process for a system-on-chip may include the following stages: a power/clock diagram drawing stage, a Verilog coding and scripting stage, a first documentation stage, a Unified Power Format/Standard Design Constraint (UPF/SDC) file generation stage, an implementation layout design stage, a second documentation stage, a Design for Testability (DFT) controller insertion stage, a hardware system analysis stage, and a software optimization stage.

In the power/clock diagram drawing stage, the power and clock structure is visually represented and drawn as a block diagram to represent the power domains and clock tree. In this stage, only the clock elements and their link relationships are simply represented in a diagram. In the Verilog coding and scripting stage, a register transfer level (RTL) design of hardware is performed by writing Verilog code and scripts to define and implement the functions of the SoC. That is, developers manually generate RTL code based on the results of the power/clock diagram drawing stage.

In the first documentation stage, the design intent and system structure are documented at the early stage of the project, and various documents—such as requirements specifications, architectural designs, and power/clock diagrams—are created for multiple stakeholders including the verification team and the software development team.

In the UPF/SDC file generation stage, unified power format (UPF) and standard design constraint (SDC) files are generated to control power management and timing constraints, and serve as inputs for hardware synthesis.

In the implementation layout design stage, the actual SoC chip layout is designed and placed at the gate level. In the second documentation stage, various documents are updated and supplemented to reflect changes in design and implementation. In the DFT controller insertion stage, a DFT controller and logic circuit for testing and debugging are designed and integrated into the SoC. In the hardware system analysis stage, the operation of the hardware is checked and analyzed through simulation and validation to ensure the accuracy and efficiency of the design. In the software optimization stage, the software code running on the SoC is profiled and optimized to improve overall performance.

Each stage of the system-on-chip design process is performed independently by various stakeholders, and the respective stages may require different types of information. That is, the information required for the first half of the project may differ from that required in the second half. For this reason, problems in the initial design results from the first half of the project may be discovered through simulation and verification in the later stages, and the earlier work may need to be repeated to resolve these issues. In addition, if the requirements or design goals change during the project, the initial design work may need to be repeated.

While these multiple stages are being repeated, multiple stakeholders must perform similar tasks again to reflect changes in other stages, which results in significant time and manpower consumption in system-on-chip design.

### SUMMARY

In view of the above problems, the present disclosure aims to provide a no-code-based system and method for designing a power management controller, which automatically generates register transfer level (RTL) code for the controller based on the settings required in the power design process of a system-on-chip.

The present disclosure can be implemented in various manners, including a device (system), a method, a computer program stored in a computer-readable medium, or a computer-readable medium having a computer program stored therein.

A system for designing a power management controller using a no-code approach according to an embodiment of the present disclosure includes a memory configured to store at least one instruction, a power manager component storage in which a root power manager component and at least one type of domain power manager component are stored, and at least one processor configured to execute the at least one instruction stored in the memory.

The at least one instruction includes instructions for generating a root power manager instance constituting a power management controller based on the root power manager component, generating at least one domain power manager instance constituting the power management controller based on the at least one type of domain power manager component, establishing a connection between an output port of the root power manager instance and an input port of the at least one domain power manager instance, allocating a memory storage space for each of the root power manager instance and the at least one domain power manager instance constituting the power management controller, and generating hardware code of power elements included in the power management controller, register code corresponding to each power element, hardware code corresponding to the ports and connections, and binary code corresponding to an operation sequence of the power management controller.

Preferably, the at least one instruction may include instructions for copying register field values and operation sequences of the root power manager component to the register field values and operation sequences of the root power manager instance, and for copying register field values and operation sequences of at least one domain power manager component to the register field values and operation sequences of each corresponding domain power manager instance.

Preferably, the at least one instruction may include instructions for setting the number of domain groups and the number of power domains connected to each domain group for the root power manager instance.

More preferably, the memory storage space allocated to the domain power manager instance may be determined based on the number of domain groups and the number of power domains included in a domain group including the domain power manager instance.

Preferably, the at least one instruction may include instructions for generating a power management interface instance connected to each of the at least one domain power manager instance through a P-link, respectively corresponding to the domain power manager instances.

Preferably, the at least one instruction may include instructions for generating at least one power instance that constitutes at least one power manager component selected from the root power manager component and the at least one type of domain power manager component, based on the at least one power component; generating a first instruction instance based on the at least one instruction component; determining a target power instance of the first instruction instance among the at least one power instance and setting a value; and generating code including an instruction, a register address, and data based on the first instruction instance, the target power instance, and the value.

More preferably, the at least one instruction may include instructions for generating a second instruction instance based on the at least one instruction component, setting a target power instance of the second instruction instance among the at least one power instance and setting a value for the second instruction instance, and setting an execution order between the first instruction instance and the second instruction instance.

More preferably, the at least one power component may be at least one of a reset component, an isolation component, a switch control component, a retention component, an automatic power management component, a reference clock gating component, a memory component, a handshake component, a clock link component, a P-channel handshake component, a user-defined output component, and a user-defined input component.

More preferably, the at least one power component may be at least one of an information register generation component, a timeout register generation component, an upper information transfer register generation component, an internal register storage component, an internal register control interrupt generation component, an external input control interrupt generation component, a timer generation component, and a domain power manager connection component.

More preferably, the at least one instruction component may be at least one of a WRITE component for writing a specific value to a specific register field, a READWAIT component for waiting for a specific value to be input to a specific register field, a WAIT component for waiting for a certain period of time, an IF component for branching according to a condition, a GOTO component for moving to a specific location, and a CALL component for moving to a specific location with the ability to return.

A method of designing a power management controller using a no-code approach according to an embodiment of the present disclosure is executed by at least one processor in a computer system including a power manager component storage in which a root power manager component and at least one type of domain power manager component are stored. The method includes generating a root power manager instance constituting the power management controller based on the root power manager component, generating at least one domain power manager instance constituting the power management controller based on the at least one type of domain power manager component, establishing a connection between an output port of the root power manager instance and an input port of the at least one domain power manager instance, allocating memory storage space for each of the root power manager instance and the at least one domain power manager instance, and generating hardware code for power elements included in the power management controller, register code corresponding to each power element, hardware code corresponding to the ports and connections, and binary code corresponding to an operation sequence of the power management controller.

Preferably, the method of designing a power management controller may include copying register field values and operation sequences of the root power manager component to the register field values and operation sequences of the root power manager instance, and copying register field values and operation sequences of at least one domain power manager component to the register field values and operation sequences of each corresponding domain power manager instance.

Preferably, the method of designing a power management controller may include setting the number of domain groups and the number of power domains connected to each domain group with respect to the root power manager instance.

More preferably, in the method of designing a power management controller, the memory storage space allocated to the domain power manager instance may be determined based on the number of domain groups and the number of power domains included in the domain group to which the domain power manager instance belongs.

Preferably, the method of designing a power management controller may include generating, for each of the at least one domain power manager instance, a power management interface instance connected to the domain power manager instance through a P-link.

Preferably, the method of designing a power management controller may include generating at least one power instance that constitutes at least one power manager component selected from the root power manager component and the at least one type of domain power manager component, based on at least one power component; generating a first instruction instance based on at least one instruction component; determining a target power instance of the first instruction instance from among the at least one power instance and setting a value; and generating code including an instruction, a register address, and data based on the first instruction instance, the target power instance, and the value.

More preferably, the method of designing a power management controller may include generating a second instruction instance based on at least one instruction component, setting a target power instance of the second instruction instance from among the at least one power instance, setting a value for the second instruction instance, and setting an execution order between the first instruction instance and the second instruction instance.

More preferably, the at least one power component may be at least one of a reset component, an isolation component, a switch control component, a retention component, an automatic power management component, a reference clock gating component, a memory component, a handshake component, a clock link component, a P-channel handshake component, a user-defined output component, and a user-defined input component.

More preferably, the at least one power component may be at least one of an information register generation component, a timeout register generation component, an upper information transfer register generation component, an internal register storage component, an internal register control interrupt generation component, an external input control interrupt generation component, a timer generation component, and a domain power manager connection component.

More preferably, the at least one instruction component may be at least one of a WRITE component for writing a specific value to a specific register field, a READWAIT component for waiting for a specific value to be input to a specific register field, a WAIT component for waiting for a certain period of time, an IF component for branching according to a condition, a GOTO component for moving to a specific location, and a CALL component for moving to a specific location with the ability to return.

A computer program stored in a computer-readable medium is provided to execute the above-described method according to an embodiment of the present disclosure.

### Advantageous Effects

In various embodiments of the present disclosure, hardware code corresponding to power manager components constituting a power management controller, as well as the connections between the power manager components, can be designed in a no-code manner, taking into account the settings required in the power design process of a system-on-chip.

In various embodiments of the present disclosure, hardware code corresponding to a power management controller-namely, register transfer level (RTL) code—can be automatically derived, thereby effectively improving the efficiency of the design process.

In various embodiments of the present disclosure, a user can derive hardware code—namely, register transfer level (RTL) code-corresponding to a power management controller in a no-code manner, even without coding knowledge or knowledge of clock processes.

In various embodiments of the present disclosure, a power management controller can be designed in consideration of settings required throughout the entire power design process, thereby enabling easy implementation of global optimization.

The effects of the present disclosure are not limited to those mentioned above, and other effects not explicitly described herein will be readily understood by those of ordinary skill in the art based on the claims.

### BRIEF DESCRIPTION OF THE DRAWINGS

Embodiments of the present disclosure will be described with reference to the accompanying drawings, wherein like reference numerals refer to like elements, but are not limited thereto.

FIG. 1 is a block diagram of a system-on-chip including a general power management controller.

FIG. 2 is a block diagram illustrating the configuration of a domain power manager of FIG. 1.

FIG. 3 is a diagram illustrating a no-code type power management controller design system according to an embodiment of the present disclosure.

FIG. 4 is a diagram illustrating an example display screen of the no-code type power management controller design system according to an embodiment of the present disclosure.

FIG. 5 is an example diagram illustrating a power management controller (PMC) displayed in a design window.

FIG. 6 is an example diagram illustrating a root power manager component displayed in a design window.

FIG. 7 is an example diagram illustrating of a domain power manager component displayed in a design window.

FIG. 8 is an example diagram illustrating an operation sequence diagram of a power manager component displayed in a design window.

FIG. 9 is an example diagram illustrating a target power instance setting screen of an arbitrary instruction instance.

FIG. 10 is a flowchart illustrating a method of designing a power management controller using a no-code approach according to the present disclosure.

FIG. 11 illustrates an exemplary computing device for performing the above-described method and/or embodiment.

### DETAILED DESCRIPTION

Hereinafter, specific embodiments of the present disclosure will be described in detail with reference to the accompanying drawings. However, detailed descriptions of well-known functions and configurations may be omitted when they are deemed to unnecessarily obscure the gist of the present disclosure.

In the accompanying drawings, identical or corresponding elements are denoted by the same reference numerals. In the descriptions of the following embodiments, repeated descriptions of the same or corresponding elements may be omitted. However, even if a description of a certain element is omitted, it should not be construed as indicating that such an element is not included in the embodiment.

The advantages and features of the embodiments disclosed in the present specification, as well as methods for achieving them, will become apparent from the following embodiments and the accompanying drawings. However, the present disclosure is not limited to the embodiments described below, but may be implemented in various forms. These embodiments are provided merely to fully convey the scope of the invention to those of ordinary skill in the art.

The terms used in this specification will first be briefly explained, followed by a detailed description of the disclosed embodiments. The terminology has been selected to the extent possible as widely used general terms while considering the functions of the present invention; however, the meanings of the terms may vary depending on the intent of those skilled in the art, judicial precedents, or the emergence of new technologies. In certain cases, some terms may have been arbitrarily selected by the applicant, and in such cases, the meanings will be specifically defined in the specification. Therefore, the terms used herein should not be interpreted merely based on their literal expressions, but should be understood in light of their meanings and the overall context of the present disclosure.

The singular forms used in this specification shall be understood to include plural forms as well, unless the context clearly indicates otherwise. Likewise, plural forms shall be understood to include singular forms unless the context clearly indicates otherwise. Furthermore, throughout the specification, when an element is referred to as “including” a particular component, this shall not be interpreted as excluding other components unless explicitly stated otherwise.

In the present disclosure, the terms “comprise,” “comprising,” and the like indicate the presence of stated features, steps, operations, elements, and/or components, but do not preclude the presence or addition of one or more other features, steps, operations, elements, components, and/or combinations thereof.

In the present disclosure, when a particular component is described as being “coupled,” “combined,” “connected,” “associated,” or “reacting” with another component, the particular component may be directly coupled, combined, connected, associated, or reacting with the other component, or may be indirectly coupled, combined, connected, associated, or reacting through one or more intermediate components. Furthermore, in the present disclosure, the term “and/or” is intended to encompass any and all combinations of one or more of the listed items, or at least a part thereof.

In the present disclosure, terms such as “first,” “second,” and the like are used merely to distinguish one component from another, and are not intended to limit the nature, order, or function of the components. For example, a “first” component may be identical or similar to a “second” component.

In various embodiments of the present disclosure, the term “power component” may refer to elements used in designing power manager components, including domain power manager components and root power manager components. Power components used for designing a domain power manager component may include a reset component, an isolation component, a switch control component, a retention component, an automatic power management component, a reference clock gating component, a memory component, a handshake component, a clock link component, a P-channel handshake component, a user-defined output component, a user-defined input component, and the like. Power components used for designing a root power manager component may include an information register generation component, a timeout register generation component, an upper information transfer register generation component, an internal register storage component, an internal register control interrupt generation component, an external input control interrupt generation component, a timer generation component, a domain power manager connection component, and the like.

In various embodiments of the present disclosure, a “power instance” refers to a power component included in a power manager component, and may be a component added to the design window by user operation. The characteristics of a power manager component may be defined by the set of power instances it contains. When a user drags and drops a power component icon from the power component window into the design window, a corresponding power instance may be created. Upon creation, a register associated with the power instance may also be automatically generated. The field values of the register may be preconfigured or modified based on user input. Both domain and root power managers may include multiple power instances corresponding to each type of power component. For example, a power instance based on a reset component is referred to as a reset instance; one based on an isolation component as an isolation instance; one based on a switch control component as a switch control instance; and one based on a retention component as a retention instance. Additional power instances may also be generated based on other power components. When a power instance is generated, its corresponding register field values may be automatically assigned, and hardware code may be generated based on those field values.

In various embodiments of the present disclosure, an “instruction component” may refer to a tool that can be utilized in the operation sequence of a domain power manager or a root power manager. The instruction components may include a WRITE component for writing a specific value to a specific register field, a READWAIT component for waiting for a specific value to be input to a specific register field, a WAIT component for waiting for a certain period of time, an IF component for branching according to a condition, a GOTO component for moving to a specific location, a CALL component for moving to a specific location with the ability to return, a LABEL component, a START component, and an END component.

In various embodiments of the present disclosure, an “instruction instance” may refer to an instruction component added to the design window by user operation. A power instance and a value may be set for each instruction instance. The instruction code may be determined based on the instruction instance, the register field address may be determined based on the power instance, and the data may be determined based on the value. A sequence composed of the instruction, register address, and data thus determined may be stored in a memory such as ROM or RAM.

In the present disclosure, a “power manager component” may refer to a tool used for designing a power management controller. The power manager component may include at least one domain power manager component and at least one root power manager component. The domain power manager and the root power manager may each independently include one or more power instances, and an operation sequence may be designed for each power instance. A user may design the domain and root power manager components using power components and instruction components, and may then design a power management controller based on the designed domain and root power manager components.

In various embodiments of the present disclosure, a “power manager instance” may refer to a power manager component added to the design window by user operation. The user may generate an icon representing the power manager instance in the design window, and may associate one of the pre-designed power manager components with the corresponding instance. When the power manager instance icon is associated with a specific power manager component in this manner, the register field values and the ROM/RAM operation sequence of the associated component may be copied to the power manager instance.

Power components and instruction components may serve as building blocks for designing individual power manager components, and a power management controller may be designed by combining such power manager components.

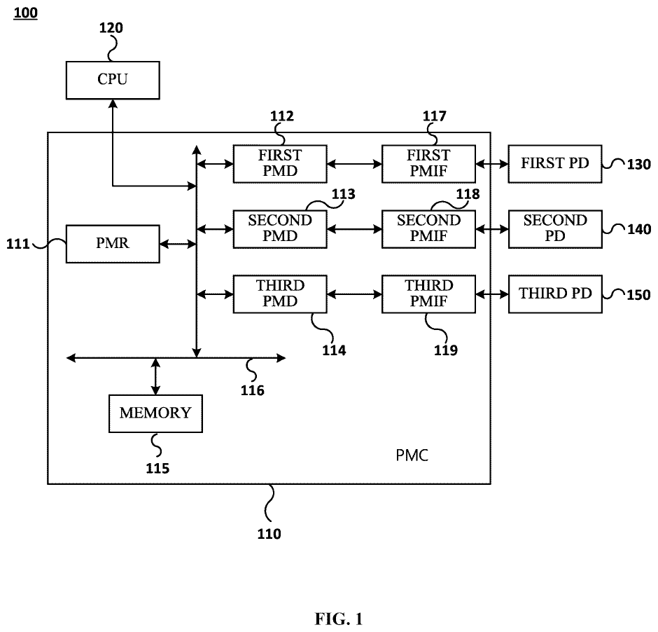

FIG. 1 is a block diagram of a system-on-chip including a general power management controller. The system-on-chip (SoC) device 100 may include a fully operational product and system within a single integrated circuit, and may be implemented as a chip, a module, or a complete system.

The SoC device 100 includes a power management controller (PMC) 110, a central processing unit (CPU) 120 configured to control the power management controller 110 via software, and one or more power domains (PDs) 130, 140, and 150. The central processing unit 120 controls the power management controller 110 and may constitute one of the power domains included in the SoC device.

The power management controller 110 may provide a power up and power down sequence for each of the one or more power domains 130, 140, and 150. Each power domain 130, 140, and 150 may process a power up sequence to enter a power up state, or process a power down sequence to enter a power down state. The system-on-chip device may include at least one power management controller 110.

The power domains 130, 140, and 150 may include a core domain including the central processing unit (CPU) 120, a memory domain including a memory subsystem such as a main memory or a cache memory, a graphics and video domain including multimedia elements such as a graphics processing unit or a video encoding/decoding device, and an input/output domain including an input/output interface element for communication with external devices. Each power domain may include one or more sub-power domains.

The power management controller 110 may include: at least one domain power manager (PMD; Power Management for Domain) 112, 113, and 114, each corresponding to one of the power domains 130, 140, and 150 and configured to control the power of the corresponding power domain; a root power manager (PMR; Power Management for Root) 111 configured to manage the domain power managers 112, 113, and 114; a memory 115 configured to store a program for operating the root power manager 111 and the domain power managers 112, 113, and 114; and at least one power management interface (PMIF) 117, 118, and 119 disposed between the domain power managers 112, 113, and 114 and the power domains 130, 140, and 150.

The root power manager 111, the domain power managers 112, 113, and 114, and the memory 115 may be disposed in an Always-On (AON) area, and the domain power managers 112, 113, and 114 may be connected to the power management interfaces 117, 118, and 119 via P-links. The power management interfaces 117, 118, and 119 may be disposed adjacent to the respective power domains 130, 140, and 150.

The at least one domain power manager 112, 113, and 114, the root power manager 111, and the memory 115 may be interconnected via an internal bus 116. The program stored in the memory 115 may include instructions and data.

The root power manager 111 may receive a system power up or power down command from the central processing unit (CPU) 120. Upon booting, the root power manager 111 may operate at least one of the domain power managers 112, 113, and 114 based on a ROM sequence (instructions and data for executing booting) to initiate booting of the system-on-chip (SoC) device 100. In addition, when a system power up or power down command is received from the CPU 120, the root power manager 111 may operate the domain power managers 112, 113, and 114 based on a RAM sequence (instructions and data for executing the command) to power on or power off the SoC device 100 or a subsystem composed of multiple power domains.

When a domain power up or power down command for controlling a power domain is received from the central processing unit (CPU) 120, at least one of the domain power managers 112, 113, and 114 may perform power up or power down sequence control on the corresponding power domain based on a RAM sequence (instructions and data for executing the command).

The first domain power manager 112 outputs a power control signal to the first power domain 130 and executes a power up/down sequence, the second domain power manager 113 outputs a power control signal to the second power domain 140 and executes a power up/down sequence, and the third domain power manager 114 outputs a power control signal to the third power domain 150 and executes a power up/down sequence. That is, since power control for the power domains 130, 140, and 150 can be executed in parallel by matching the separate domain power managers 112, 113, and 114 to the power domains 130, 140, and 150, efficient and rapid processing can be performed.

The memory 115 stores, as binary code, instructions and data for executing system power up and power down commands by the root power manager 111, and domain power up and power down commands by the domain power managers 112, 113, and 114. The memory 115 may include a ROM and a RAM.

Although FIG. 1 illustrates an SoC device including three power domains and three domain power managers, the number of power domains may vary depending on the complexity of the SoC device, and the number of domain power managers may be correspondingly changed.

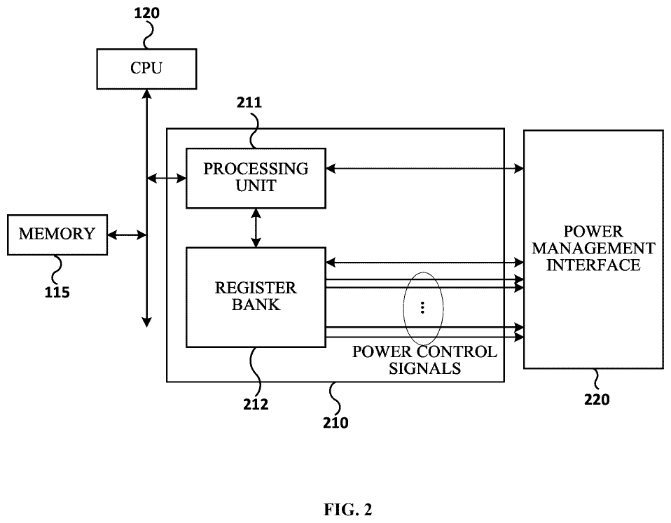

FIG. 2 is a block diagram illustrating the configuration of a domain power manager of FIG. 1.

The domain power manager 210 may transmit power control signals to a power domain through a power management interface 220 and execute a power up and power down sequence of the power domain. Accordingly, the power domain can transition from a power up state to a power down state, or from a power down state to a power up state. The power control signals for executing the power up and power down sequence may include a reset signal (RESET), an isolation signal (ISOLATION), a switch control signal (SWITCH CONTROL), and a retention signal (RETENTION), among others. These power control signals may be added, removed, or modified according to the specifications of the power domain.

The domain power manager 210 of FIG. 2 may be one of the first domain power manager 112, the second domain power manager 113, and the third domain power manager 114 of FIG. 1. The power management interface 220 of FIG. 2 may be one of the power management interfaces 117, 118, and 119 of FIG. 1. In the design of the domain power manager, the binary code of a program including instructions and data to be executed by the domain power manager 210 may be stored in the memory 115.

The central processing unit 120 outputs a domain power up and power down command for power control of a power domain to the domain power manager 210. When the domain power up and power down command is received, the domain power manager 210 transmits power control signals to the power domain through the corresponding power management interface 220 to execute a power up and power down sequence. Accordingly, the power domain transitions to a power up state or a power down state.

The domain power manager 210 includes a processing unit 211 that receives a domain power up and power down command related to power control of a power domain from the central processing unit 120, accesses the memory 115 in which instructions for executing the command are stored, and executes the instructions stored in the memory 115; and a register bank 212 in which at least one field value is changed by the processing unit 211 so that power control signals are transmitted to the power domain. The processing unit 211 includes a plurality of power elements, and each power element may correspond to one of the power control signals.

The processing unit 211 may include at least one of a power element for transmitting a reset signal to a power domain, a power element for transmitting an isolation signal to the power domain, a power element for transmitting a switch control signal to the power domain, a power element for transmitting a retention signal to the power domain, a power element for automatically executing power up and power down by a trigger signal of hardware, a power element for gating a reference clock supplied to the power domain, a power element for generating a power control signal to a memory of the power domain, a power element for generating a handshake control signal with respect to the power domain, a power element for generating a link control signal with respect to a clock management unit, a power element for generating a P-channel handshake control signal with respect to the power domain, a power element for generating a user-defined output signal within the power domain, or a power element for generating a user-defined input signal within the power domain. Such power elements constituting the processing unit 211 may be configured by creating a power instance and generating hardware code based on the power instance in the design system of the present disclosure.

The register bank 212 may include a plurality of register fields corresponding to power elements constituting the processing unit 211. A power element for transmitting and receiving a power control signal to or from a power domain may change the value of the corresponding register field, and the value recorded in the corresponding register field may be transmitted to the power domain as a power control signal. For example, a power element for transmitting a reset signal may change the value of a register field corresponding to the reset signal of the register bank 212 to 0 or 1, at this time, 0 or 1 is transmitted to a reset port of the power domain. In addition, a power element for transmitting an isolation signal may change the value of a register field corresponding to the isolation signal of the register bank 212 to 0 or 1, at this time, 0 or 1 is transmitted to an isolation port of the power domain. Similarly, a power element corresponding to a switch control signal or a retention signal may change the value of a register field corresponding to the switch control signal or the retention signal of the register bank 212 to 0 or 1, at this time, 0 or 1 is transmitted to a switch control port or a retention port of the power domain. For such operations of the processing unit, the memory 115 may further store the addresses of register fields on which instructions are to be executed, in addition to instructions and data; this may be referred to as a ROM/RAM sequence.

The instructions stored in the memory 115 include an instruction for writing a specific register field value of the register bank 212 to 0 and an instruction for writing a specific register field value of the register bank 212 to 1. The processing unit 211 executes the instruction to change the specific register field value of the register bank 212 to 0 or 1. Then, the value of the corresponding power control signal is changed to 0 or 1 and transmitted to the power domain.

The power management interface 220 may receive a signal from a power domain and transmit the signal to at least one of the processing unit 211 and the register bank 212. Among the power control signals, there are many signals based on handshaking. For example, after a power switch enable signal is transmitted, it is necessary to wait until a feedback signal in response thereto is received. At this time, the feedback signal output from the power domain is recorded as a specific register field value of the register bank 212 through the power management interface 220, and the processing unit 211 waits until the specific value is recorded in the register field. To this end, the instructions stored in the memory 115 may include an instruction for waiting until a specific register field value of the register bank 212 becomes 0, and an instruction for waiting until the register field value becomes 1.

In addition, among the power control signals, there may be cases where one signal is transmitted and a certain period of time must elapse before the next operation is executed. For example, when a power domain is reset and released, it is necessary to wait until the reset power domain starts operating normally. To this end, the instructions stored in the memory 115 may include an instruction for waiting for a specific number of cycles, and the wait time information may be stored in a specific register field of the register bank 212 or, alternatively, a constant value input by a user may be stored in an internal register of the processing unit.

In addition, the instructions stored in the memory 115 may include an instruction for writing an internal register value of the processing unit 211 to a specific register field of the register bank 212, an instruction for writing a specific register field value of the register bank 212 to an internal register of the processing unit 211, and an instruction for writing a user-input constant value to the internal register of the processing unit 211. The instructions stored in the memory 115 may also include instructions for determining the execution order of the instructions stored in the memory 115, and such instructions may include an instruction for jumping to a specific address, an instruction for returning to a previous address, and an instruction for moving to a specific address according to the result of executing an instruction.

Similar to the domain power manager, the memory 115 may store a program including instructions and data to be executed by the root power manager 111. The central processing unit 120 may modify and store the program including the instructions and data in the memory 115. The central processing unit 120 may output a system power up and power down command to the root power manager 111.

The memory 115 stores instructions to be executed by the root power manager 111 in response to a system power up and power down command, and when the system power up and power down command is received from the central processing unit 120, the root power manager 111 executes the instructions stored in the memory 115 and transmits power control signals to at least one of the domain power managers 112, 113, and 114 to control power.

As described above, it is necessary to design a power management controller 110 to control the power of multiple power domains constituting a system-on-chip, in which each of the domain power managers 112, 113, and 114 controls the power of the power domains 130, 140, and 150 through the power management interfaces 117, 118, and 119, respectively, the root power manager 111 controls the plurality of domain power managers 112, 113, and 114, and the power management controller is composed of at least one root power manager 111 and at least one domain power manager 112, 113, and 114.

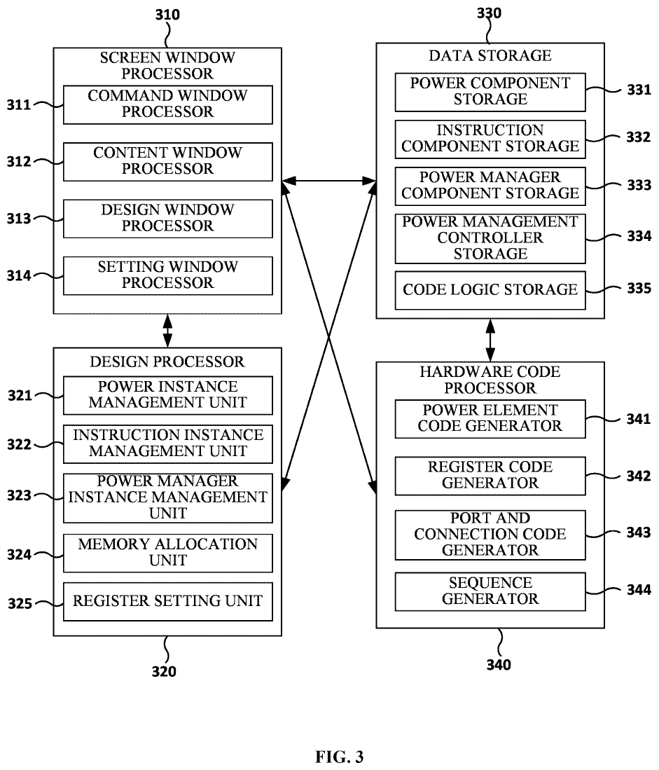

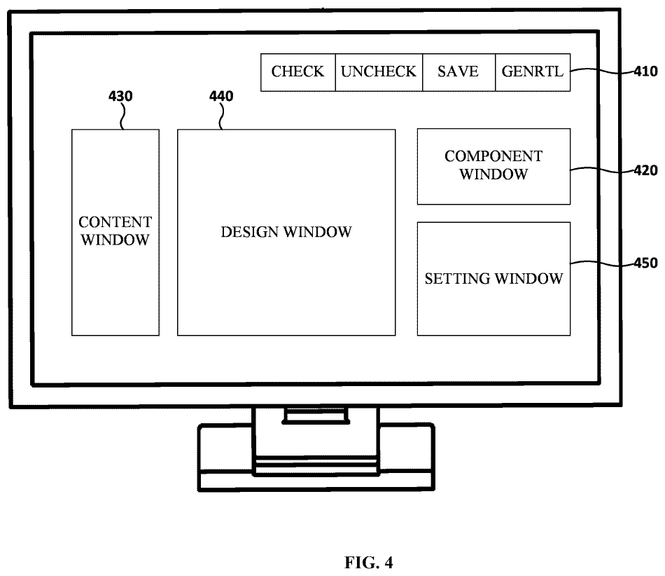

FIG. 3 is a diagram illustrating a no-code type power management controller design system according to an embodiment of the present disclosure, and FIG. 4 is a diagram illustrating an example display screen of the no-code type power management controller design system according to an embodiment of the present disclosure. The no-code type power management controller design system according to the present disclosure may be implemented as a computer system.

The power management controller design system according to the present disclosure may be a system for designing the power management controller 110 of FIG. 1.

As illustrated in FIG. 3, the power management controller design system according to the present disclosure may include: a screen window processor 310 configured to detect a user input and output a processing result for the user input on a display screen; a design processor 320 configured to generate at least one power manager instance for configuring a power management controller based on power manager component information, establish a connection between power manager instances, allocate memory according to the number of power manager instances, and set registers defining functions of the power manager instances; a data storage 330 configured to store hardware code logic for generating the designed power management controller as hardware code and software code logic for generating an operation sequence of the designed power management controller; and a hardware code processor 340 configured to generate hardware code and register code of the power manager instances based on designed power manager instance information, generate port and connection code for inter-instance connections, and store the operation sequence of the power manager instances in memory.

As illustrated in FIG. 4, the display screen of the power management controller design system according to the present disclosure may include: a command window 410 for inputting user commands; a component window 420 in which power manager component icons are displayed; a content window 430 for providing an environment for adding, deleting, and modifying a list of power management controllers being designed, and for displaying a list of power manager components and a list of power manager instances included in the power management controllers being designed; a design window 440 for displaying a diagram of a power management controller being designed and for providing an environment for adding, deleting, and modifying power manager instances; and a setting window 450 for providing an environment for modifying setting values for a power manager instance selected through the design window 440.

In the present disclosure, a power manager component may be designed prior to designing a power management controller. To this end, the design processor 320 may generate power instances included in the power manager component using a power component and may design an operation sequence of the power instances using an instruction component. In addition, the component window 420 may display power component icons and instruction component icons, and the design window 440 may provide an environment for adding, deleting, and modifying at least one power instance constituting the power manager component being designed, and may also provide an environment for adding, deleting, and modifying instruction instances for setting operation sequences for the power instances of the power manager component.

The power manager component may include a root power manager component and a domain power manager component.

The command window 410 may include: a CHECK button configured to receive a check command for errors in a power management controller being designed, a power manager component being designed, and power instances being designed; an UNCHECK button configured to receive a command for deactivating the check result; a SAVE button configured to receive a save command for a power management controller being designed, a power manager component being designed, and power instances displayed in the design window 440; and a GENRTL button configured to receive a hardware code generation command for power manager instances displayed in the design window 440.

The component window 420 may display a list of power component icons and a list of instruction component icons that can be used in designing a power manager component, and a list of power manager components that can be used in designing a power management controller.

If a power manager component to be designed is a domain power manager, power components may include a reset component for transmitting a reset signal to a power domain, an isolation component for transmitting an isolation signal to the power domain, a switch control component for transmitting a switch control signal to the power domain, a retention component for transmitting a retention signal to the power domain, an automatic power management component for automatically executing power up and power down by a hardware trigger signal, a reference clock gating component for gating a reference clock supplied to the power domain, a memory component for generating a power control signal to a memory of the power domain, a handshake component for generating a handshake control signal with respect to the power domain, a clock link component for generating a link control signal with respect to a clock management unit, a P-channel handshake component for generating a P-channel handshake control signal with respect to the power domain, a user-defined output component for generating a user-defined output signal in the power domain, and a user-defined input component for generating a user-defined input signal in the power domain.

If a power manager component to be designed is a root power manager, power components may include a component for creating a register used for information purposes in software, a component for creating a register used for timeout purposes in software, a component for creating a register used for transmitting information between upper-layer software and the root power manager, a component for storing specific signal values input to the root power manager in an internal register of the root power manager, a component for generating an interrupt based on control of the internal register of the root power manager, a component for generating an interrupt based on an external input applied to an input port of the root power manager, a component for creating an internal timer, and a component for creating a slot for connecting a domain power manager under the root power manager.

When designing a power management controller, power manager components may include a root power manager component and a domain power manager component, and may further include multiple types of root power manager components and multiple types of domain power manager components. Here, the fact that two power manager components are of different types may mean that the power instances constituting the power manager components or the operation sequences of the power instances are different.

The instruction component may include a WRITE component for writing a specific value to a specific register field, a READWAIT component for waiting for a specific value to be input to a specific register field, a WAIT component for waiting for a certain period of time, an IF component for branching based on a condition, a GOTO component for moving to a specific location, and a CALL component for moving to a specific location with returnability. The auxiliary instruction component may include a LABEL component, a START component, and an END component. The instruction component and the auxiliary instruction component may have unique border shapes. For example, the WRITE component and the READWAIT component may have rectangular borders, the IF component may have a diamond-shaped border, and the LABEL component may have an arrow-shaped border. The LABEL component may be used in connection with the instruction component and may allow two or more instruction components that are spatially separated to be functionally connected. At least two LABEL components may be used in the design window, and each LABEL component may be assigned a name and a color for identification.

The design window 440 displays a diagram of a power management controller being designed and provides an environment for adding, deleting, and modifying power manager instances.

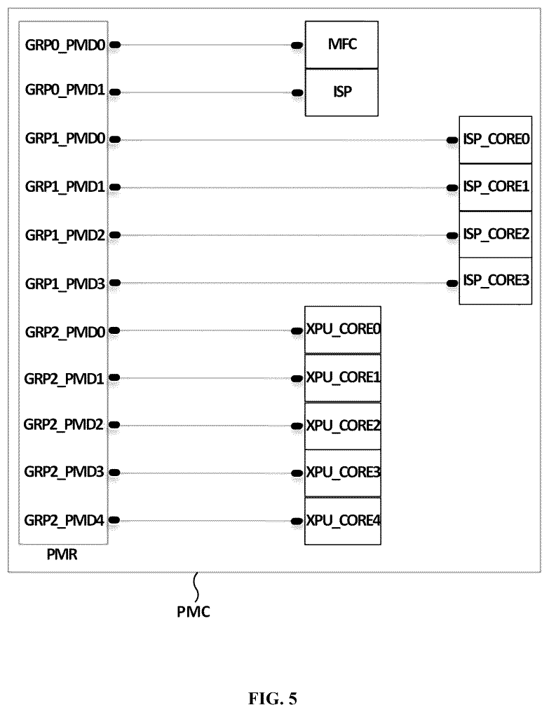

FIG. 5 is an example diagram illustrating a power management controller (PMC) displayed in the design window. The power management controller may be composed of one root power manager instance PMR and eleven domain power manager instances MFC, ISP, ISP_CORE0 to ISP_CORE3, and XPU_CORE0 to XPU_CORE4, but is not limited thereto.

A user may set the number of domain groups and the number of power domains per domain group for the root power manager instance displayed in the design window. When the number of domain groups and the number of power domains per group are set, output ports corresponding to the total number of power domains may be generated. The power management controller of FIG. 5 illustrates an example in which eleven domain power manager instances are divided into three domain groups. The first domain group includes two power domains, the second domain group includes four power domains, and the third domain group includes five power domains. Accordingly, eleven output ports may be generated for the root power manager instance.

The domain power manager instances MFC and ISP of the first group may be connected to the GRP0_PMD0 to GRP0_PMD1 ports of the root power manager instance. The domain power manager instances ISP_CORE0 to ISP_CORE3 of the second group may be connected to the GRP1_PMD0 to GRP1_PMD3 ports of the root power manager instance. The domain power manager instances XPU_CORE0 to XPU_CORE4 of the third group may be connected to the GRP2_PMD0 to GRP2_PMD4 ports of the root power manager instance. In the drawing, MFC, ISP, ISP_CORE0 to ISP_CORE3, and XPU_CORE0 to XPU_CORE4 represent the names of domain power manager instances, and MFC, ISP, and CORE may be domain power manager components of different types. For example, after designing domain power manager components of MFC type, ISP type, and CORE type, a power management controller may be designed by combining one MFC-type domain power manager instance, one ISP-type domain power manager instance, and nine CORE-type domain power manager instances, but the present disclosure is not limited thereto.

In addition, the design window 440 displays power instances of a power manager component being designed and provides an environment for adding, deleting, and modifying the power instances constituting the power manager component.

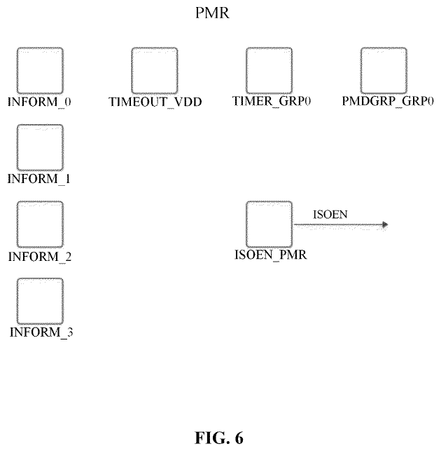

FIG. 6 is an example diagram illustrating a root power manager component displayed in the design window. The root power manager component may be composed of eight power instances, including four information instances INFORM_0, INFORM_1, INFORM_2, and INFORM_3, one timeout instance TIMEOUT_VDD, one timer instance TIMER_GRP0, one slot generation instance PMDDGRP_GRP0, and one isolation instance ISOEN_PMR, but the present disclosure is not limited thereto.

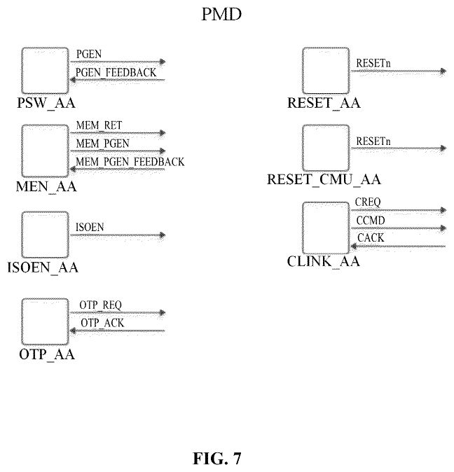

FIG. 7 is an example diagram illustrating a domain power manager component displayed in the design window. The domain power manager component may be composed of seven power instances, including one switch control instance PSW_AA, one reset instance RESET_AA, one isolation instance ISOEN_AA, one memory instance MEM_AA, one handshake instance OTP_AA, one clock link instance CLINK_AA, and one clock reset instance RESET_CMU_AA, but the present disclosure is not limited thereto.

After the addition of power instances of the power manager component is completed, the design window 440 may display an operation sequence diagram to enable the establishment of connection relationships between instruction instances.

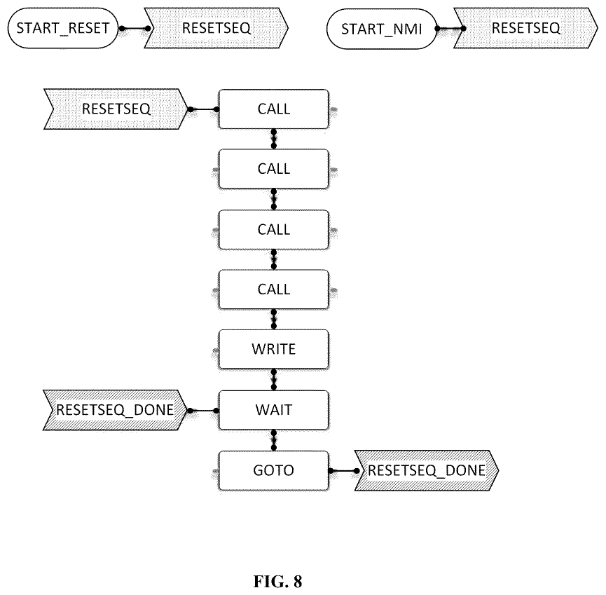

FIG. 8 is an example diagram of an operation sequence diagram of a power manager component displayed in the design window. In the operation sequence of FIG. 8, two power instances, RESET and NMI, may be set to the same process. Two START instances, START RESET and START_NMI, and a CALL instance may be functionally connected through a LABEL instance RESETSEQ. Other isolated instruction instances may be connected through a LABEL instance that is connected to the rear end of the CALL instance. In the example diagram of FIG. 8, CALL, WRITE, WAIT, and GOTO instances are used, but the present disclosure is not limited thereto.

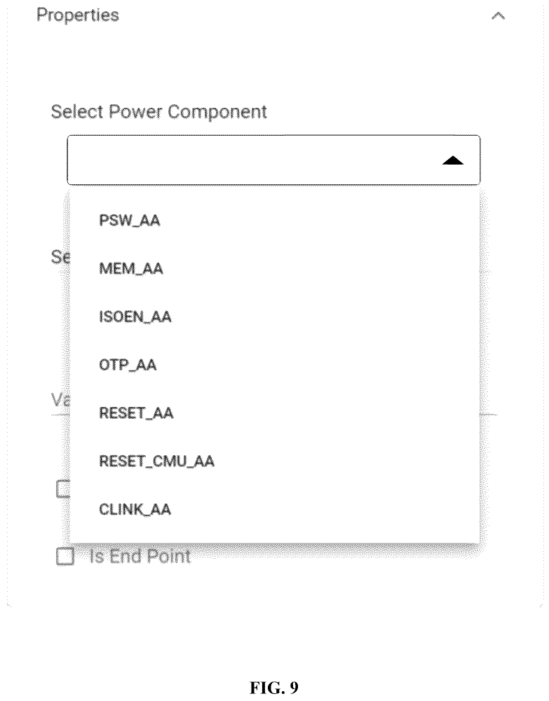

For each instruction instance, a power instance that is the execution target and a value may be set. FIG. 9 is an example diagram illustrating a screen for setting a target power instance of an arbitrary instruction instance. When an instruction instance is added, all power instances included in the corresponding power manager component may be displayed so that one power instance among them can be selected. In FIG. 9, PSW_AA to CLINK_AA are names of power instances that constitute the power manager component, and may be used for setting one power instance among them for each instruction instance.

The connection relationship between instruction instances may be represented by arrows connecting the instruction instances, and such a connection relationship may determine the execution order of the instruction instances. The present disclosure may perform design by representing the operation sequence of the power manager component in the form of a flowchart.

When the user moves a power component from the component window 420 to the design window 440 by a drag-and-drop operation, a power instance may be added to the corresponding power manager component being designed, and upon creation of the power instance, a new power instance list and register information of the new power instance may be hierarchically added to the content window 430. In addition, when the user moves a power manager component from the component window 420 to the design window 440 by a drag-and-drop operation, or creates a power manager instance icon on the design window 440 and matches it with any power manager component, a power manager instance corresponding to the power manager component may be created, and in this case, the register field values and the ROM/RAM operation sequence of the power manager component may be copied to the register field values and the ROM/RAM operation sequence of the power manager instance, respectively.

The setting window 450 displays an environment for changing setting values of a power instance selected in the design window 440, an environment for selecting and changing a power instance for an instruction instance selected in the design window 440, and an environment for inputting a value.

The screen window processor 310 may include: a command window processor 311 that displays buttons for receiving a user command on the command window 410 and detects input of each button of the command window 410 to allow an operation corresponding to the button to be executed; a content window processor 312 that hierarchically displays a list of power management controllers being designed, a list of power manager instances included in each power management controller being designed, a list of power manager components, a list of power instances included in each power manager component, and register information on the content window 430, and detects a user input on the content window 430 to allow an operation corresponding to the user input to be executed; a design window processor 313 that displays a diagram of a power management controller being designed and a diagram of a power manager component being designed selected by the user on the design window 440, and detects a user input on the design window 440 to allow an operation corresponding to the user input to be executed; and a setting window processor 314 that displays setting information of a power instance and a power manager instance selected by the user or setting information of an instruction instance selected by the user on the setting window 450, and detects a user input on the setting window 450 to allow an operation corresponding to the user input to be executed.

When the CHECK button is selected, the command window processor 311 checks for errors in the diagram of the power management controller being designed, in the power manager instances constituting the power management controller, and in the types and setting values of power instances included in each power manager instance, and the command window processor 311 causes parts with errors to be displayed. When the UNCHECK button is selected, the command window processor 311 restores the parts with errors displayed in the diagram of the power management controller to their original state and displays them. When the SAVE button is selected, the command window processor 311 stores the power management controller being designed and its subcomponents displayed in the design window 440 in the data storage 330. When the GENRTL button is selected, the command window processor 311 generates hardware code for the power management controller being designed displayed in the design window 440 and binary code for the operation sequence.

The content window processor 312 displays a list of power management controllers being designed, a list of power manager instances included in each power management controller being designed, and a list of power instances included in each power manager instance in the content window 430, and provides an environment for adding, deleting, and changing the power management controllers. The content window processor 312 may display a list of power manager instances included in each power management controller being designed under each power management controller being designed, and hierarchically display a list of power instances included in each power manager instance being designed and register information of each power instance under each power management instance being designed. In addition, the content window processor 312 may further display power manager component list information in the content window 430. The power management controller may include at least one root power manager instance and at least one domain power manager instance connected to the root power manager instance.

The user may add, delete, or rename a power management controller on the content window 430, and the list of power management controllers in the power management controller storage 334 may be added, deleted, or renamed in response to user input. When the user renames a power management controller, the content window processor 312 may cause not only the name of the power management controller but also the names of power manager instances under the power management controller, power instances under the power manager instances, and registers of the power instances to be changed all at once.

The design window processor 313 causes the design window 440 to display a diagram of a power management controller being designed and provides an environment for adding, deleting, and changing power manager instances that constitute the power management controller being designed. In addition, the design window processor 313 causes the diagram of each power manager component being designed to be displayed and provides an environment for adding, deleting, and changing power instances that constitute the power manager component being designed.

When designing a power manager component, if the user performs an operation of adding an arbitrary power component of the component window 420 to the design window 440, the design window processor 313 detects this and causes a power instance adding operation to be executed. In addition, if the user performs an operation of adding an arbitrary instruction component of the component window 420 to the design window 440, the design window processor 313 detects this and causes an instruction instance adding operation to be executed. When designing a power management controller, if the user performs an operation of adding a power manager component to the design window 440, the design window processor 313 detects this and causes a power manager instance adding operation to be executed.

The setting window processor 314 causes the setting window 450 to display setting information of a power instance selected by the user and detects a user input applied to the setting window 450 to cause an operation corresponding to the user input to be executed. In addition, the setting window processor 314 causes setting information of an instruction instance selected by the user to be displayed and detects a user input applied to the setting window 450 to cause an operation corresponding to the user input to be executed.

The data storage 330 may include a power component storage 331 in which power component information is stored, an instruction component storage 332 in which instruction component information is stored, a power manager component storage 333 in which power manager component information is stored, a power management controller storage 334 in which a list of power management controllers being designed, a list of power manager instances for each power management controller being designed, a list of power instances for each power manager instance, register information corresponding to each power instance, and an operation sequence for each power manager instance are stored, and a code logic storage 335 in which hardware code logic for generating hardware code based on power manager instances that constitute a designed power management controller and register information is stored.

The power component information stored in the power component storage 331 may include an address range allocated to each power component and a register offset size for each individual power component. The power component information defines a register address and field value of a power instance generated based on the corresponding power component. A maximum number of power instances may be calculated for each power component using the address range allocated to each power component and the register offset size of each individual power component. Different address ranges, different register offset sizes, and different setting field information may be determined for respective power components.

The power components may include at least one of a reset component, an isolation component, a switch control component, a retention component, an automatic power management component, a reference clock gating component, a memory component, a handshake component, a clock link component, a P-channel handshake component, a user-defined output component, and a user-defined input component.

In addition, the power components may include at least one of a component for creating a register used for information purposes in software, a component for creating a register used for timeout purposes in software, a component for creating a register used for information transmission between upper software and the root power manager, a component for storing specific signal values input to the root power manager in an internal register of the root power manager, a component for generating an interrupt by control of the internal register of the root power manager, a component for generating an interrupt by an external input applied to an input port of the root power manager, a component for generating an internal timer, and a component for creating a slot for connecting a domain power manager under the root power manager.

The instruction components stored in the instruction component storage 332 may include a WRITE component for writing a specific value to a specific register field, a READWAIT component for waiting for a specific value to be input to a specific register field, a WAIT component for waiting for a certain period of time, an IF component for branching according to a condition, a GOTO component for moving to a specific location, and a CALL component for moving to a specific location with return capability. In addition, auxiliary instruction components may include a LABEL component, a START component, and an END component. The instruction components and the auxiliary instruction components may have unique border shapes. For example, the WRITE component and the READWAIT component may have rectangular borders, the IF component may have a diamond-shaped border, and the LABEL component may have an arrow-shaped border. The LABEL component may be used in connection with an instruction component, and may allow any two instruction components that are separated from each other to be substantially connected. A name and a color for identification may be set for the LABEL component.

The power manager component storage 333 may store power manager components for designing a power management controller. The power manager components may include root power manager components and domain power manager components. Each power manager component may include at least one power instance and may include an operation sequence of the power instances. The operation sequence may be designed based on instruction components and may include target power instances and corresponding values for each instruction instance. That is, when the instruction component is a WRITE component, the target power instance (e.g., a reset instance or an isolation instance) and the value (data) to be written need to be set. Here, the power instance corresponds to the target power instance, and the value refers to the value to be written. Since a register field is determined for each power instance in the present disclosure, when the target power instance of an instruction instance is determined, the field address of the power instance can be obtained.

An instruction instance may be a WRITE instance based on the WRITE component, a READWAIT instance based on the READWAIT component, a WAIT instance based on the WAIT component, an IF instance based on the IF component, a GOTO instance based on the GOTO component, or a CALL instance based on the CALL component. The target power instance may be one of the power instances that constitute a power manager component being designed. The value may be a decimal number or a hexadecimal number.

The power management controller storage 334 may hierarchically store a list of power manager instances included in a power management controller being designed, a list of power instances included in each power manager instance, register information for each power instance, and an operation sequence of each power manager instance.

The code logic storage 335 stores hardware code logic for generating hardware code based on a plurality of power manager instances constituting a designed power management controller, a plurality of power instances under the power manager instances, and register information, and stores software code logic for generating binary code including instructions, register addresses, and data for driving power elements generated by the power manager instances based on designed instruction instances.

The design processor 320 may include a power instance management unit 321 that generates at least one power instance constituting a power manager component and stores it in the power manager component storage 333; an instruction instance management unit 322 that stores at least one instruction instance and an execution order of any two instruction instances, sets a target power instance and a value for each instruction instance, and stores them in the power manager component storage 333; a power manager instance management unit 323 that generates at least one power manager instance constituting a power management controller based on power manager components generated by the power instance management unit 321 and the instruction instance management unit 322, sets a connection between the power manager instances, and stores them in the power management controller storage 334; a memory allocation unit 324 that divides memory based on the number of power manager instances included in the power management controller and allocates a memory area for each power manager instance; and a register setting unit 325 that sets a field value of a register that defines the function of a power instance for each power manager instance.

The power instance management unit 321 may be executed when the user adds any power component from the component window 420 to the design window 440 during the process of designing a power manager component, thereby creating a new power instance. The name of the new power instance may include the name of the power manager component to which the new power instance belongs and the type information of the power component. In addition, the address of the new power instance may be set based on information of a previously generated power instance of the same power component type and the power component information. That is, the start address of the register of the new power instance may be determined by adding the start address and the register offset size of the register of the previously generated power instance, and the initial setting value of the register field may be determined based on the register field information of the power component. The user may design the power manager component by adding the new power instance.

The instruction instance management unit 323 may set at least one instruction instance and a connection relationship between instruction instances according to the operation sequence of the power manager component. Each instruction instance may include a target power instance and a value. The instruction instance management unit 323 may add a LABEL instance between any two instruction instances. A pair of LABEL instances may be recognized as the same point, and thus two instruction instances that are spatially separated may be substantially connected by using the pair of LABEL instances. In addition, a START instance and an END instance may be added at the start and end points of the operation sequence to define the start and end. The user may set the operation sequence of the power manager component through the instruction instance management unit 323.

The user may design at least one type of root power manager component and at least one type of domain power manager component using the power instance management unit 321 and the instruction instance management unit 322, and the designed root power manager component and domain power manager component may be stored in the power manager component storage 333. The root power manager component may set domain groups controlled by the corresponding root power manager and the number of power domains for each domain group. When the domain groups and the number of power domains for each domain group are set, output ports of the root power manager component may be created, and the names of the respective ports may be determined based on the domain group names.

The power manager instance management unit 323 may be executed when at least one of at least one type of root power manager component and at least one type of domain power manager component is added to the design window 440 to create a power manager instance. When a root power manager component is added, a root power manager instance is additionally created, and when a domain power manager component is added, a domain power manager instance is created, and a power management interface instance connected to the corresponding domain power manager instance via a P-link may also be automatically created. When a power manager instance is created, the register field values and the operation sequence of the corresponding power manager component may be copied to the power manager instance.

The power manager instance management unit 323 may change the number of domain groups of the root power manager instance and the number of power domains per domain group, and accordingly, the output ports of the root power manager instance may be changed. The name of each output port may be generated based on the name of the domain group and the number of power domains connected to the corresponding domain group. Input ports may be generated in the domain power manager instance, and a connection may be formed between the output ports of the root power manager instance and the input ports of the domain power manager instance through user operation. This connection may be utilized to generate hardware code.

The memory allocation unit 324 may allocate a memory section to each power manager instance based on the type and number of power manager instances that constitute a power management controller. A storage space at an upper address of the memory may be allocated to the root power manager instance, and a storage space at a lower address may be allocated to the domain power manager instance. The memory allocation unit 324 may be configured to include a ROM allocation rule and a RAM allocation rule based on the number of domain groups and the number of domain power managers for each domain group, and may allocate ROM and RAM storage spaces to each domain power manager instance accordingly.

The register setting unit 325 may display the field name, bit position, and the like of the register field of each power instance included in each power manager instance in the design window 440 or the setting window 450, and may modify them according to user input.

The hardware code processor 340 includes: a power element code generator 341 that generates power element code based on a designed power manager instance and designed power instance information; a register code generator 342 that generates register code corresponding to a power element; a port and connection code generator 343 that generates hardware code corresponding to ports and connections for connection between power manager instances; and a sequence generator 344 that generates binary code for the operation sequence of a power management controller.

The hardware code processor 340 may be executed when the GENRTL button of the command window 410 is selected. The user may execute the GENRTL button by selecting it while the diagram of a power management controller being designed is displayed in the design window 440, and may also verify in advance whether there is an error in the diagram by executing the CHECK button before executing the GENRTL button.

The power element code generator 341 converts information on the power instances constituting the designed power management controller in accordance with the hardware code logic stored in the code logic storage 335 to generate hardware code for all power elements constituting the power management controller. The port type of the power elements and the hierarchical structure of the hardware module may be determined according to the settings of the designed power instances.

The register code generator 342 generates register code of a register bank based on the register field values of the designed power instance in accordance with the hardware code logic, and a port of the register bank corresponding to a port of the power element may be generated. The port and connection code generator 343 generates hardware code corresponding to each port and connection of the power manager instances constituting the designed power management controller, connects the ports of the power elements and the ports of the register bank in accordance with the hardware code logic, and generates hardware code corresponding to the respective ports and connections.

The sequence generator 344 generates binary code corresponding to the operation sequence of the power manager instances constituting the power management controller based on the software code logic stored in the code logic storage 335. The operation sequence may include instructions, a register address, and data. The instructions may be derived based on instruction instances, the register address may be derived based on a target power instance, and the data may be derived based on a value.

The binary code of the operation sequence derived in this way is stored in the storage space of the memory allocated to each power manager instance by the memory allocation unit 324, and the processing unit 211 may read the binary code and execute the corresponding instruction for the address of the register bank to transmit a power control signal to a power domain.

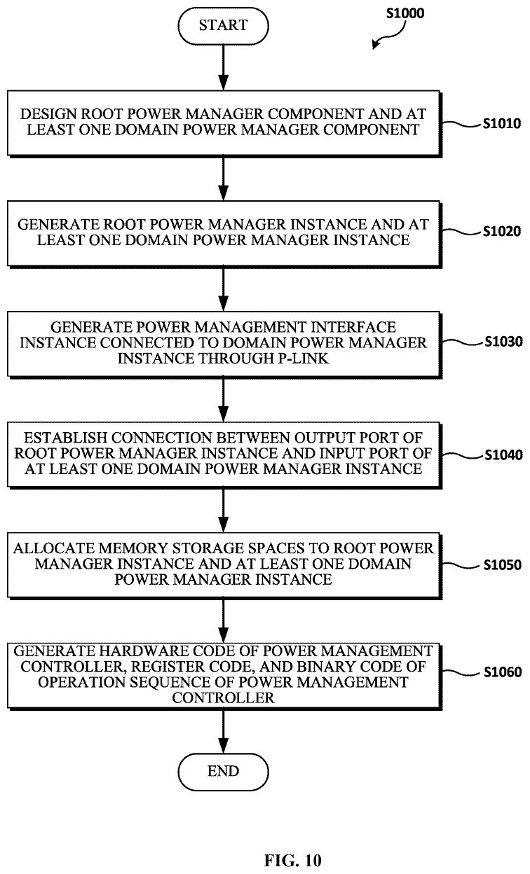

FIG. 10 is a flowchart illustrating a method of designing a power management controller in a no-code manner according to the present disclosure. The method of designing a power management controller according to the present disclosure may be executed by a processor of a computer system.

The computer system includes a power manager component storage in which power manager component information is stored, and a code logic storage in which hardware code logic is stored for generating hardware code based on a plurality of power manager instances constituting a designed power management controller, a plurality of power instances under the power manager instances, and register information.

The processor designs at least one root power manager component and at least one domain power manager component (S1010). The root power manager component includes at least one power instance and may have an operation sequence set. The domain power manager component includes at least one power instance and may have an operation sequence set. The at least one domain power manager component may be designed as different types. The root power manager component may set the number of domain groups and the number of power domains connected to each domain group.

Next, the processor creates a root power manager instance based on the root power manager component and creates domain power manager instances based on one or more domain power manager components (S1020). The root power manager instance copies register field information and the operation sequence of the root power manager component, and each of the domain power manager instances copies register field information and the operation sequence of the corresponding domain power manager component on which it is based.

Next, the processor creates a power management interface instance connected to each domain power manager instance via a P-link (S1030). The processor may automatically create the power management interface instance without user operation.

Next, the processor forms a connection between the output port of the root power manager instance and the input ports of one or more domain power manager instances (S1040).

Next, the processor allocates memory storage space to the root power manager instance and the one or more domain power manager instances (S1050). The memory storage space allocated to the domain power manager instances may be determined based on the number of domain groups and the number of power domains connected to each domain group.

Next, the processor generates hardware code for the power elements constituting the power management controller, register code, and binary code of the operation sequence of the power management controller (S1060).

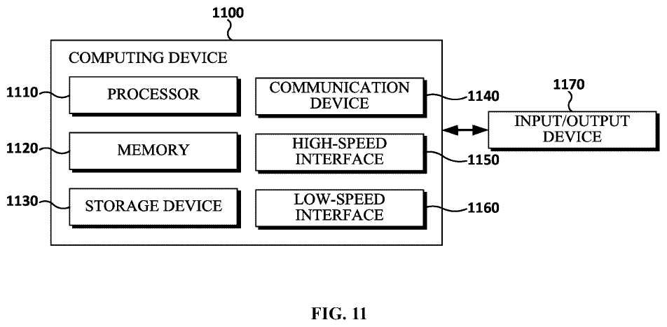

FIG. 11 illustrates an exemplary computing device 1100 for performing the above-described method and/or embodiment. According to an embodiment, the computing device 1100 may be implemented using hardware and/or software configured to interact with a user. Here, the computing device 1100 may include a laptop, a desktop, a workstation, a personal digital assistant, a server, a blade server, a main frame, etc., but the present disclosure is not limited thereto. The components of the computing device 1100, interconnections of the components, and functions of the components are exemplary and do not limit the embodiments of the present disclosure described and/or claimed herein.

The computing device 1100 includes a processor 1110, a memory 1120, a storage device 1130, a communication device 1140, a high-speed interface 1150 connected to the memory 1120 and a high-speed expansion port, and a low-speed interface 1160 connected to a low-speed bus and the storage device. The components 1110, 1120, 1130, 1140, 1150, and 1160 may be interconnected using various buses, may be mounted on the same main board, or may be mounted and connected in another suitable manner. The processor 1110 may be configured to process instructions of a computer program by performing basic arithmetic, logic, and input/output operations. For example, the processor 1110 may process instructions stored in the memory 1120 and the storage device 1130 and/or instructions executed in the computing device 1100 to display graphic information on an external input/output device 1170, such as a display device coupled to the high-speed interface 1150.

The communication device 1140 may provide a configuration or function for the input/output device 1170 and the computing device 1100 to communicate with each other through a network, and may provide a configuration or function for supporting the input/output device 1170 and/or the computing device 1100 to communicate with other external devices. For example, a request or data generated by a processor of an external device according to any program code may be transmitted to the computing device 1100 through a network under the control of the communication device 1140. On the other hand, a control signal or an instruction provided under the control of the processor 1110 of the computing device 1100 may be transmitted to another external device through the communication device 1140 and the network.

Although the computing device 1100 includes one processor 1110 and one memory 1120 in FIG. 11, the present disclosure is not limited thereto, and the computing device 1100 may be implemented using multiple memories, multiple processors, and/or multiple buses. Further, although FIG. 11 illustrates a single computing device 1100, the present disclosure is not limited thereto, and multiple computing devices may interact and perform operations necessary to execute the above-described method.

The memory 1120 may store information within the computing device 1100. According to an embodiment, the memory 1120 may be configured as a volatile memory unit or multiple memory units. Additionally or alternatively, the memory 1120 may be configured as a non-volatile memory unit or multiple memory units. In addition, the memory 1120 may be configured as another type of computer-readable media, such as a magnetic disc or an optical disc. In addition, the memory 1120 may store an operating system and at least one program code and/or instruction.

The storage device 1130 may be one or more mass storage devices for storing data for the computing device 1100. For example, the storage device 1130 may be a computer-readable medium including, or configured to include, a magnetic disc such as a hard disk or a removable disk, an optical disc, a semiconductor memory device such as an erasable programmable read-only memory (EPROM), an electrically erasable PROM (EEPROM), or a flash memory device, a CD-ROM, a DVD-ROM disk, etc. In addition, a computer program may be tangibly implemented in such a computer-readable medium.

The high-speed interface 1150 and the low-speed interface 1160 may be means for interfacing with the input/output device 1170. For example, the input device may include devices such as a camera including an audio sensor and/or an image sensor, a keyboard, a microphone, and a mouse, and the output device may include devices such as a display, a speaker, and a haptic feedback device. In another example, the high-speed interface 1150 and the low-speed interface 1160 may be means for interfacing with devices in which components or functions for performing input and output are integrated, such as touchscreens.

In an embodiment, the high-speed interface 1150 may manage bandwidth-intensive operations for the computing device 1100, whereas the low-speed interface 1160 may manage less bandwidth-intensive operations than the high-speed interface 1150, but such functional allocation is merely exemplary. In an embodiment, the high-speed interface 1150 may be coupled to the memory 1120, the input/output devices 1170, and high-speed expansion ports that may accommodate various expansion cards (not shown). In addition, the low-speed interface 1160 may be coupled to the storage device 1130 and low-speed expansion ports. Additionally, the low-speed expansion ports, which may include various communication ports (e.g., USB, Bluetooth, Ethernet, and wireless Ethernet), may be coupled to one or more input/output devices 1170, such as a keyboard, a pointing device, and a scanner, or a networking device, such as a router or a switch via a network adapter.

The computing device 1100 may be implemented in different forms. For example, the computing device 1100 may be implemented as a standard server, or may be implemented as a group of such standard servers. Additionally or alternatively, the computing device 1100 may be implemented as part of a rack server system, or may be implemented as a personal computer, such as a laptop computer. In this case, components of the computing device 1100 may be combined with other components within any mobile device (not shown). The computing device 1100 may include one or more other computing devices, or may be configured to communicate with one or more other computing devices.

Although the input/output device 1170 is not included in the computing device 1100 in FIG. 11, the present disclosure is not limited thereto, and the input/output device 1170 may be integrated into the computing device 1100. In addition, although the high-speed interface 1150 and/or the low-speed interface 1160 are illustrated in FIG. 11 as elements configured separately from the processor 1110, the present disclosure is not limited thereto, and the high-speed interface 1150 and/or the low-speed interface 1160 may be configured to be included in the processor 1110.

The above-described method and/or various embodiments may be realized by digital electronic circuits, computer hardware, firmware, software, and/or a combination thereof. The various embodiments of the present disclosure may be executed by a data processing device, for example, one or more programmable processors and/or one or more computing devices, or implemented as a computer-readable medium and/or a computer program stored in a computer-readable medium. The above-described computer program may be written in any form of programming language, including compiled or interpreted languages, and may be distributed in any form, such as a standalone program, a module, a subroutine, or the like. The computer program may be distributed through a single computing device, multiple computing devices connected through the same network, and/or multiple computing devices distributed to be connected through multiple different networks.

The above-described method and/or various embodiments may be performed by one or more processors configured to execute one or more computer programs that process, store, and/or manage any function, functions, etc. by operating based on input data or generating output data. For example, the method and/or various embodiments of the present disclosure may be performed by a special purpose logic circuit such as a field programmable gate array (FPGA) or an application specific integrated circuit (ASIC), and the device and/or the system for performing the method and/or embodiments of the present disclosure may be implemented as a special purpose logic circuit such as an FPGA or an ASIC.

The one or more processors executing the computer program may include a general purpose or special purpose microprocessor and/or one or more processors of any kind of digital computing device. The processor may receive instructions and/or data from each of a read-only memory and a random access memory, or may receive instructions and/or data from the read-only memory and the random access memory. In the present disclosure, the components of the computing device performing the method and/or embodiments may include one or more processors for executing instructions, and one or more memories for storing instructions and/or data.

In an embodiment, the computing device may transmit/receive data to/from one or more large-capacity storage devices for storing data. For example, the computing device may receive data from a magnetic disc or an optical disc and transmit data to the magnetic disc or the optical disc. Computer-readable media suitable for storing instructions and/or data associated with a computer program may include any form of non-volatile memory, including a semiconductor memory device such as an erasable programmable read-only memory (EPROM), an electrically erasable PROM (EEPROM), and a flash memory device, but the present disclosure is not limited thereto. For example, the computer-readable media may include a magnetic disc, such as an internal hard disk or a removable disk, a photomagnetic disc, a CD-ROM, and a DVD-ROM.

To provide interaction with a user, the computing device may include a display device (e.g., a cathode ray tube (CRT), a liquid crystal display (LCD), or the like) for providing or displaying information to a user, and a pointing device (e.g., a keyboard, a mouse, a trackball, or the like) for enabling the user to provide input and/or commands to the computing device. That is, the computing device may further include any other types of devices for providing interaction with the user. For example, the computing device may provide any form of sensory feedback, including visual feedback, auditory feedback, and/or tactile feedback, to the user for interaction with the user. In this regard, the user may provide input to the computing device through various gestures, such as voice and motion.

In the present disclosure, various embodiments may be implemented in a computing device including a back-end component (e.g., a data server), a middleware component (e.g., an application server), and/or a front-end component. In this case, the components may be interconnected by any form or medium of digital data communication, such as a communication network. According to an embodiment, the communication network may be a wired network such as Ethernet, a wired home network (power line communication), a telephone line communication device, and RS-serial communication, a mobile communication network, a wireless LAN (WLAN), Wi-Fi, Bluetooth, and ZigBee, or a combination thereof. For example, the communication network may include a local area network (LAN), a wide area network (WAN), etc.

The computing device based on the exemplary embodiments described herein may be implemented using hardware and/or software configured to interact with a user, including a user device, a user interface (UI) device, a user terminal, or a client device. For example, the computing device may include a portable computing device such as a laptop computer. Additionally or alternatively, the computing device may include a personal digital assistant (PDAs), a tablet PC, a game console, a wearable device, an Internet of Things (IoT) device, a virtual reality (VR) device, an augmented reality (AR) device, and the like, but the present disclosure is not limited thereto. The computing device may further include other types of devices configured to interact with a user. Furthermore, the computing device may include a portable communication device (e.g., a mobile phone, a smart phone, a wireless cellular phone, and the like) suitable for wireless communication over a network, such as a mobile communication network. he computing device may be configured to wirelessly communicate with a network server using wireless communication technologies and/or protocols, such as Radio Frequency (RF), Microwave Frequency (MWF), and/or Infrared Ray Frequency (IRF).

The various embodiments including specific structural and functional details in the present disclosure are exemplary. Therefore, the embodiments of the present disclosure are not limited to those described above, and may be implemented in various other forms. In addition, the terms used in the present disclosure are intended to describe some embodiments and are not to be construed as limiting the embodiments. For example, the singular words may be construed to include plural forms unless the context clearly indicates otherwise.

In the present disclosure, unless otherwise defined, all terms used in this specification, including technical or scientific terms, have the same meaning as commonly understood by a person skilled in the art to which such concepts belong. In addition, commonly used terms, such as terms defined in dictionaries, should be interpreted as having a meaning consistent with the meaning in the context of the relevant technology.

Although the present disclosure has been described in connection with some embodiments herein, various modifications and changes may be made without departing from the scope of the present disclosure as understood by a person skilled in the art to which the present disclosure belongs. In addition, such modifications and changes should be considered to fall within the scope of the appended claims.

### DETAILED DESCRIPTION OF MAIN ELEMENTS

310: screen window processor
311: command window processor
312: content window processor
313: design window processor
314: setting window processor
320: design processor
321: power instance management unit
322: instruction instance management unit
323: power manager instance management unit
324: memory allocation unit
325: register setting unit
330: data storage
331: power component storage
332: instruction component storage
333: power manager component storage
334: power management controller storage
335: code logic storage
340: hardware code processor
341: power element code generator
342: register code generator
343: port and connection code generator
344: sequence generator
410: command window
420: component window
430: content window
440: design window
450: setting window

What is claimed is:

1. A system for designing a power management controller using a no-code approach, the system comprising:
a memory configured to store at least one instruction;
a power manager component storage in which a root power manager component and at least one type of domain power manager component are stored; and
at least one processor configured to execute the at least one instruction stored in the memory,
wherein the at least one instruction includes instructions for:
generating a root power manager instance based on the root power manager component and generating at least one domain power manager instance based on the at least one type of domain power manager component, each constituting the power management controller;
establishing a connection between an output port of the root power manager instance and an input port of the at least one domain power manager instance;
allocating a memory storage space for each of the root power manager instance and the at least one domain power manager instance; and
generating hardware code of power elements included in the power management controller, register code corresponding to each power element, hardware code corresponding to the ports and the connections, and binary code corresponding to an operation sequence of the power management controller.

2. The system of claim 1, wherein the at least one instruction includes instructions for copying register field values and operation sequences of the root power manager component to the register field values and operation sequences of the root power manager instance, and copying register field values and operation sequences of at least one domain power manager component to the register field values and operation sequences of each corresponding domain power manager instance.

3. The system of claim 1, wherein the at least one instruction includes instructions for setting, with respect to the root power manager instance, the number of domain groups and the number of power domains connected to each domain group.

4. The system of claim 3, wherein the memory storage space allocated to the domain power manager instance is determined based on the number of domain groups and the number of power domains included in the domain group to which the domain power manager instance belongs.

5. The system of claim 1, wherein the at least one instruction includes instructions for generating, for each of the at least one domain power manager instance, a power management interface instance connected to the domain power manager instance through a P-link.

6. The system of claim 1, further comprising a power component storage in which at least one power component is stored and an instruction component storage in which at least one instruction component is stored,
wherein the at least one instruction includes instructions for:
generating at least one power instance that constitutes at least one power manager component selected from the root power manager component and the at least one type of domain power manager component, based on the at least one power component;
generating a first instruction instance based on the at least one instruction component;
determining a target power instance of the first instruction instance from among the at least one power instance, and setting a value for the first instruction instance; and
generating code including an instruction, a register address, and data based on the first instruction instance, the target power instance, and the value.

7. The system of claim 6, wherein the at least one instruction includes instructions for:
generating a second instruction instance based on the at least one instruction component;
setting a target power instance of the second instruction instance from among the at least one power instance, and setting a value for the second instruction instance; and
setting an execution order between the first instruction instance and the second instruction instance.

8. The system of claim 6, wherein the at least one power component is at least one of a reset component, an isolation component, a switch control component, a retention component, an automatic power management component, a reference clock gating component, a memory component, a handshake component, a clock link component, a P-channel handshake component, a user-defined output component, and a user-defined input component.

9. The system of claim 6, wherein the at least one power component is at least one of an information register generation component, a timeout register generation component, an upper information transfer register generation component, an internal register storage component, an internal register control interrupt generation component, an external input control interrupt generation component, a timer generation component, and a domain power manager connection component.

10. The system of claim 6, wherein the at least one instruction component is at least one of a WRITE component for writing a specific value to a specific register field, a READWAIT component for waiting for a specific value to be input to a specific register field, a WAIT component for waiting for a certain period of time, an IF component for branching according to a condition, a GOTO component for moving to a specific location, and a CALL component for moving to a specific location with the ability to return.

11. A method of designing a power management controller using a no-code approach, executed by at least one processor in a computer system including a power manager component storage in which a root power manager component and at least one type of domain power manager component are stored, the method comprising:
generating a root power manager instance based on the root power manager component and at least one domain power manager instance based on the at least one type of domain power manager component, the instances constituting the power management controller;
establishing a connection between an output port of the root power manager instance and an input port of the at least one domain power manager instance;
allocating a memory storage space for each of the root power manager instance and the at least one domain power manager instance; and
generating hardware code of power elements included in the power management controller, register code corresponding to each power element, hardware code corresponding to the ports and connections, and binary code corresponding to an operation sequence of the power management controller.

12. The method of claim 11, further comprising copying register field values and operation sequences of the root power manager component to the register field values and operation sequences of the root power manager instance, and copying register field values and operation sequences of the at least one domain power manager component to the register field values and operation sequences of each corresponding domain power manager instance.

13. The method of claim 11, further comprising setting, with respect to the root power manager instance, the number of domain groups and the number of power domains connected to each domain group.

14. The method of claim 13, wherein the memory storage space allocated to the domain power manager instance is determined based on the number of domain groups and the number of power domains included in the domain group to which the domain power manager instance belongs.

15. The method of claim 11, further comprising generating, for each of the at least one domain power manager instance, a power management interface instance connected to the domain power manager instance through a P-link.

16. The method of claim 11, further comprising:
generating at least one power instance that constitutes at least one power manager component selected from the root power manager component and the at least one type of domain power manager component, based on at least one power component;
generating a first instruction instance based on the at least one instruction component;
determining a target power instance of the first instruction instance from among the at least one power instance, and setting a value for the first instruction instance; and
generating code including an instruction, a register address, and data based on the first instruction instance, the target power instance, and the value.

17. The method of claim 16, further comprising:
generating a second instruction instance based on the at least one instruction component;
setting a target power instance of the second instruction instance from among the at least one power instance, and setting a value for the second instruction instance; and
setting an execution order between the first instruction instance and the second instruction instance.

18. The method of claim 16, wherein the at least one power component is at least one of a reset component, an isolation component, a switch control component, a retention component, an automatic power management component, a reference clock gating component, a memory component, a handshake component, a clock link component, a P-channel handshake component, a user-defined output component, and a user-defined input component.

19. The method of claim 16, wherein the at least one power component is at least one of an information register generation component, a timeout register generation component, an upper information transfer register generation component, an internal register storage component, an internal register control interrupt generation component, an external input control interrupt generation component, a timer generation component, and a domain power manager connection component.

20. The method of claim 16, wherein the at least one instruction component is at least one of a WRITE component for writing a specific value to a specific register field, a READWAIT component for waiting for a specific value to be input to a specific register field, a WAIT component for waiting for a certain period of time, an IF component for branching according to a condition, a GOTO component for moving to a specific location, and a CALL component for moving to a specific location with the ability to return.
